(19) United States
(12) Patent Application Publication
(10) Pub. No.: US 2025/0182590 A1
(43) Pub. Date: Jun. 5, 2025

(54) CONTROL SYSTEM FOR CONTROLLING A CLAW MACHINE, AND CLAW MACHINE ASSEMBLY INCLUDING THE CONTROL SYSTEM

(71) Applicant: PAOKAI ELECTRONIC ENTERPRISE CO., LTD., Kaohsiung City (TW)

(72) Inventor: Ming-Shan WEI, Kaohsiung City (TW)

(21) Appl. No.: 18/442,405

(22) Filed: Feb. 15, 2024

(30) Foreign Application Priority Data
Dec. 1, 2023 (TW) 112146869

(51) Int. Cl. G07F 17/32; G05D 3/12

(52) U.S. Cl. CPC G07F 17/3295; G05D 3/12; G07F 17/3202; G07F 17/3297

(57) ABSTRACT

A control system for controlling a claw machine includes a limiting member that is inclined toward a claw of the claw machine, a location sensor, and a processor. In response to user-operation, the processor generates a dropping signal to drop the claw, and generates a closing electrical signal to control the claw to close. The processor generates a lifting signal to lift the claw. The location sensor generates a proximity signal when the claw is in proximity. In response to receipt of the proximity signal, the processor generates a signal to lift the claw for a predetermined lifting distance. After the signal is transmitted for a preset time, the processor generates an opening pulse signal to reduce a grip strength of the claw.

### CROSS-REFERENCE TO RELATED APPLICATION

This application claims priority to Taiwanese Invention patent application No. 112146869, filed on Dec. 1, 2023, and incorporated by reference herein in its entirety.

### FIELD

The disclosure relates to a control system for controlling a claw machine, and a claw machine assembly that includes the control system.

### BACKGROUND

FIG. 1 illustrates a conventional claw machine including a cabinet that defines a passage, a claw that is disposed in the cabinet and that may be operated by a player using an interface, and a plurality of objects (e.g., stuffed animals) that are disposed in the cabinet, wherein each of the objects may be grabbed by the claw and moved through the passage to the player as a prize. Recently, arcades with a plurality of claw machines have become popular. The claw machines in a same arcade may be rented out to and run by different owners, who may individually decide the kind of objects to be placed in the cabinet, the level of grabbing strength of the claw mechanism, etc.

As the prizes become more attractive, the players continuously develop new ways to operate the claws so as to increase the chances of winning the prizes. On the other hand, the owners of the claw machines may implement countering measures in an attempt to prevent the players from easily winning the prizes, in order to ensure a profit.

### SUMMARY

Therefore, an object of the disclosure is to provide a control system that can balance gameplay and chances of winning prices associated with a claw machine.

According to one embodiment of the disclosure, the control system is for controlling a claw machine. The claw machine includes a cabinet that defines an inner space and a claw mechanism that is disposed on a ceiling of the cabinet. The claw mechanism includes a shell, a cable reel that is disposed in the shell, a cable that has one end connected to the cable reel, a rotating motor that is connected to the cable reel to control the movement of the cable reel, a claw that is connected to another end of the cable, and a driving module that is configured to control the claw to close or open based on a control signal. The control system includes:
a limiting member that has an installation part installed on the shell of the claw mechanism, and an inclination part extending from the installation part and inclined toward the claw;
a location sensor that is installed on the shell of the claw mechanism, and that is configured to generate a proximity signal when an object comes into proximity of the location sensor;
an operation interface that is connected to the rotating motor and the driving module, and that is operable to control operations of the claw mechanism; and
a processor connected to the location sensor, the operation interface, the rotating motor and the driving module.

In response to user-operation on the operation interface, the processor generates and transmits a dropping signal to the rotating motor to cause the rotating motor to control the movement of the cable reel and release the cable, thereby dropping the claw. In response to other user-operation on the operation interface, the processor generates and transmits a closing electrical signal to the driving module to cause the driving module to control the claw to close.

The processor generates and transmits a lifting signal to the rotating motor to cause the rotating motor to control the movement of the cable reel and retract the cable, thereby lifting the claw. In the case where the claw has come into proximity of the location sensor, the location sensor generates a proximity signal and transmits the proximity signal to the processor;

In response to receipt of the proximity signal, the processor generates and transmits a fixed-distance movement signal to the rotating motor, so as to cause the rotating motor to retract the cable, thereby lifting the claw for a predetermined lifting distance.

After the fixed-distance movement signal is transmitted for a preset period, the processor generates and transmits an opening pulse signal to the driving module, so as to adjust the closing electrical signal from the driving module such that a grip strength of the claw is reduced.

Another object of the disclosure is to provide a claw machine assembly that includes a claw machine and the above-mentioned control system.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 illustrates a conventional claw machine.

FIG. 2 illustrates a control system to be used with a claw machine according to one embodiment of the disclosure.

FIG. 3 is a block diagram illustrating the components of the control system and the claw mechanism according to one embodiment of the disclosure.

FIG. 4 illustrates an exemplary limiting member of the control system according to one embodiment of the disclosure.

FIG. 5 illustrates the use of the claw machine in a first operation mode according to one embodiment of the disclosure.

FIG. 6 illustrates a claw being dropped to break full contact with the limiting member.

FIG. 7 illustrates the signal transmission between the processor and the claw mechanism in a second operation mode.

FIG. 8 illustrates the signal transmission between the processor and the claw mechanism in a third operation mode.

FIG. 9 illustrates the different grip strengths of the claw over time in response to one exemplary modulated electrical signal.

FIG. 10 illustrates the different grip strengths of the claw over time in response to another exemplary modulated electrical signal.

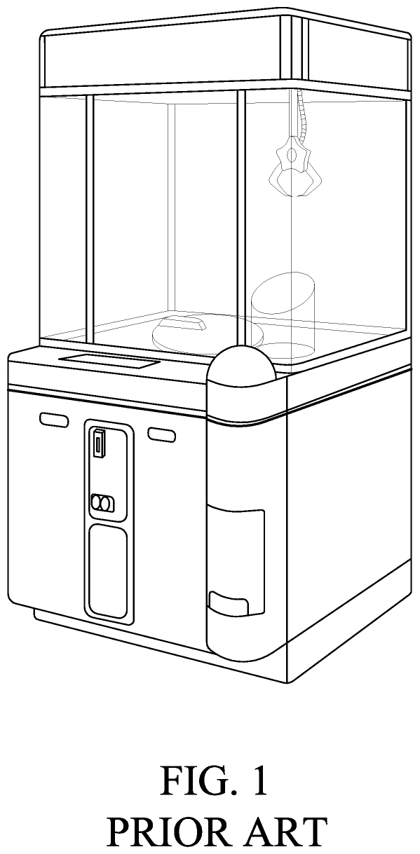

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

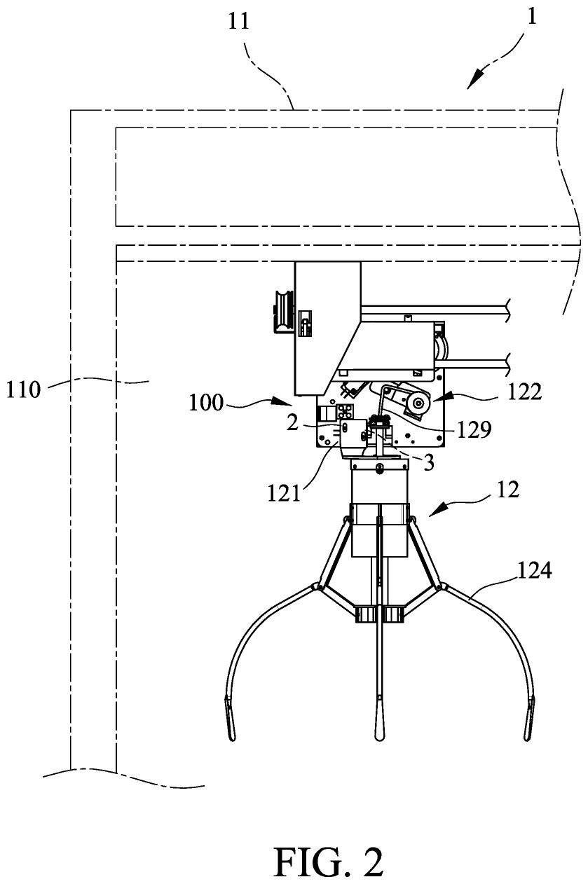

FIG. 2 illustrates a control system 100 to be used with a claw machine 1 according to one embodiment of the disclosure.

The claw machine 1 includes a cabinet 11 that defines an inner space 110 and an object passage (not shown) spatially connected to the inner space 110, and a claw mechanism 12 that is disposed on a ceiling of the cabinet 11. In use, the inner space 110 may be filled with a plurality of objects as prizes, and a player who inserts a coin or a token may grab one of the objects in the inner space 110, and move the one of the objects through the object passage so as to obtain the one of the objects (i.e., to “win a prize”).

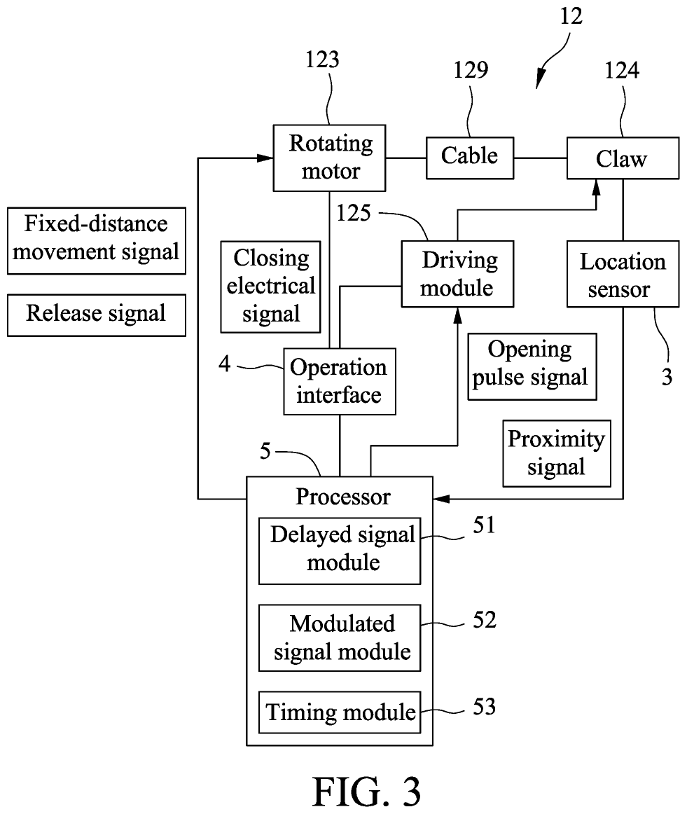

FIG. 3 is a block diagram illustrating the components of the control system 100 and the claw mechanism 12 according to one embodiment of the disclosure. Referring back to FIG. 2, in this embodiment, the claw mechanism 12 may be installed on a horizontal movement mechanism (e.g., a crane) disposed on the ceiling of the cabinet 11, and includes a shell 121, a cable reel 122 that is disposed in the shell 121, a cable 129 that is to be stored in the cable reel 122, a rotating motor 123 that is connected to the cable reel 122 to control the movement of the cable reel 122, a claw 124 that is connected to one end of the cable 129 distal from the cable reel 122, and a driving module 125 that is configured to control the claw 124 to close or open based on a control signal.

In use, the cable 129 may be controlled by the movement of the cable reel 122 (e.g., rotation in one direction) to extend out of the cable reel 122, thereby lowering the claw 124 toward the bottom of the inner space 110, and may be controlled by the movement of the cable reel 122 (e.g., rotation in an opposite direction) to retract into the cable reel 122, thereby lifting the claw 124. The claw 124 may be embodied using an electrical claw (or an electromagnetic claw) that is configured to be actuated by an electrical signal from the driving module 125 so as to close (to grab an object) or open (to release the object). It is noted that a grabbing strength of the claw 124 may be positively related to an electrical voltage associated with the electrical signal. That is to say, when the electrical signal has a greater electrical voltage, the claw 124 is controlled to close with a greater force so as to grip one of the objects more firmly. On the other hand, when the electrical signal has a smaller electrical voltage, the claw 124 is controlled to close with a smaller force so as to grip one of the objects less firmly.

The control system 100 includes a limiting member 2, a location sensor 3, an operation interface 4, and a processor 5.

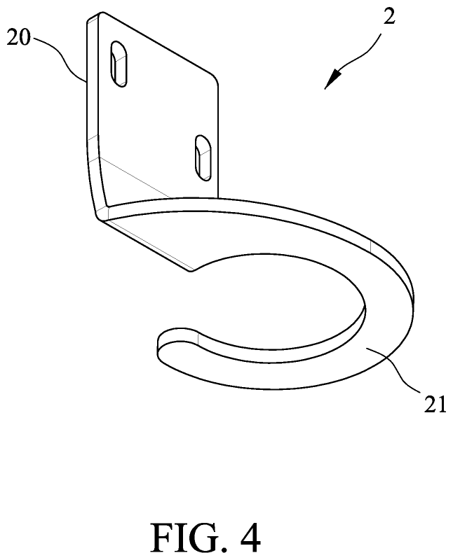

FIG. 4 illustrates an exemplary limiting member 2 according to one embodiment of the disclosure. The limiting member 2 has an installation part 20 that is installed on the shell 121 of the claw mechanism 12, and an inclination part 21 extending from the installation part 20. In some embodiments, the limiting member 2 is formed using a metal material, and may be installed on the shell 121 using one or more screws. When installed on the shell 121, the inclination part 21 is inclined by a specific angle with respect to a horizontal plane, and is inclined toward the claw 124. It is noted that a direction in which a bottom surface of the inclination part 21 faces may be manually adjusted to accommodate different uses.

The location sensor 3 may be embodied using a proximity sensor, and is installed on the shell 121 of the claw mechanism 12 and disposed adjacent to the inclination part 21 of the limiting member 2.

The operation interface 4 is connected to the rotating motor 123 and the driving module 125, and is operable by a player to control operations of the claw mechanism 12.

Specifically, in some embodiments, the operation interface 4 is embodied using a joystick that controls movement of the claw mechanism 12 (via the horizontal movement mechanism) and a button to control the claw 124 to move down and to attempt to grab an object below.

The processor 5 is connected to the location sensor 3, the operation interface 4, the rotating motor 123, and the driving module 125. The processor 5 may include, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. The driving module 125 may include a controller, such as a motor controller or a microcontroller, etc.

Typically, when a player inserts a coin or a token into the claw machine 1 (e.g., via a coin slot), a game then commences, and the player may operate the operation interface 4 in an attempt to grab an object. Specifically, the joystick controls the horizontal movement mechanism to move the claw mechanism 12 within a horizontal plane, and the button, when pressed, controls a number of operations of the rotating motor 123 and the driving module 125. For example, in response to user-operation on the operation interface 4 (e.g., after the button is pressed), the processor 5 generates and transmits a dropping signal to the rotating motor 123. In response to receipt of the dropping signal, the rotating motor 123 is configured to rotate and to control the movement of the cable reel 122, so as to cause the cable 129 to drop the claw 124 downwardly. After the claw 124 has been moved to a specific height, other user-operation on the operation interface 4 (e.g., the button is pressed once again) may make the processor 5 generate and transmit a closing electrical signal to the driving module 125 to cause the driving module 125 to control the claw 124 to close. Then, the processor 5 transmits a lifting signal to the rotating motor 123. In response to the lifting signal, the rotating motor 123 is configured to rotate in an opposite direction, and to control the movement of the cable reel 122 so as to retract the cable 129 and cause the cable 129 to lift the claw 124 upwardly. Then, the horizontal movement mechanism is controlled to move the claw 124 above the object passage, and then processor 5 generates and transmits an opening electrical signal to the driving module 125 so as to cause the claw 124 to open, thereby dropping the object.

In some embodiments, the interface 4 may include additional buttons, and the operations of generating the dropping signal to drop the claw 124 and generating the closing electrical signal to control the claw 124 to close may be initiated separately by pressing different buttons. As such, the player may decide, during the drop of the claw 124, when to cause the claw 124 to close. Then, in response to user-operation on the operation interface 4, the processor 5 generates and transmits the closing electrical signal.

In this embodiment, the processor 5 includes a number of modules for implementing a number of functions. Each of the modules may be implemented using a microchip that is pre-programmed to implement the functions as described below, but is not limited to such.

In this embodiment, the processor 5 includes a delayed signal module 51, a modulated signal module 52, and a timing module 53. It is noted that the processor 5 may be pre-programmed to implement additional functions as described below.

During actual use, an owner of the claw machine 1 may set the claw machine 1 to operate in one or more of operation modes. It is noted that in some embodiments, different operation modes may be applied together.

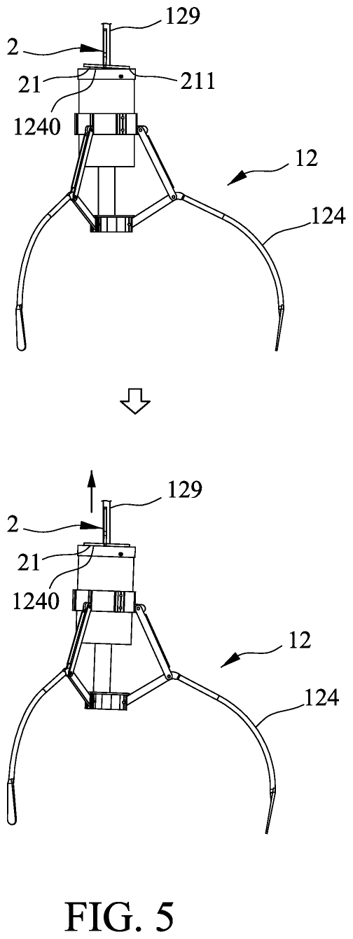

FIG. 5 illustrates the use of the claw machine 1 in a first operation mode according to one embodiment of the disclosure. In the first operation mode, while the claw 124 is closed and is being lifted, the location sensor 3 is configured to detect whether the claw 124 comes into proximity (e.g., within a certain distance) of the location sensor 3 (i.e., being in proximity of the inclination part 21). In the case where the claw 124 has come into proximity of the location sensor 3, the location sensor 3 generates a proximity signal and transmits the proximity signal to the processor 5. In response to receipt of the proximity signal, the processor 5 is configured to generate and transmit a fixed-distance movement signal to the rotating motor 123, so as to cause the rotating motor 123 to retract the cable 129 for a predetermined time period at a constant speed (thereby lifting the claw 124 by a predetermined lifting distance). In some embodiments, the predetermined lifting distance may be set such that after the claw 124 has been lifted for the predetermined lifting distance, a top surface 1240 of the claw 124 comes into contact with the bottom surface of the inclination part 21 of the limiting member 2. That is to say, since that the inclination part 21 is not parallel to the ground, when the top surface 1240 of the claw 124 is in contact with the bottom surface of the inclination part 21, the claw 124 is tilted by a certain angle as well.

After the fixed-distance movement signal is transmitted for a preset period, during a period that the claw 124 is being tilted, (i.e., the period between a moment that a part of the top surface 1240 of the claw 124 comes into contact with the inclination part 21 at, for example, a lowest point 211, and a moment that the top surface 1240 comes into full contact with the bottom surface of the inclination part 21), the processor 5 generates an opening pulse signal (i.e., a short duration signal) and transmits the opening pulse signal to the driving module 125. In response to receipt of the opening pulse signal, the driving module 125 is configured to adjust the closing electrical signal from the driving module 125 such that the electrical voltage of the closing electrical signal is decreased for a short duration. As a result, a grip strength of the claw 124 is reduced, and the grip of the claw 124 on the object is loosened, and due to the momentum of the claw 124 being tilted, the object may be “swung” out of the claw 124 based on a shape and/or orientation of the inclination part 21.

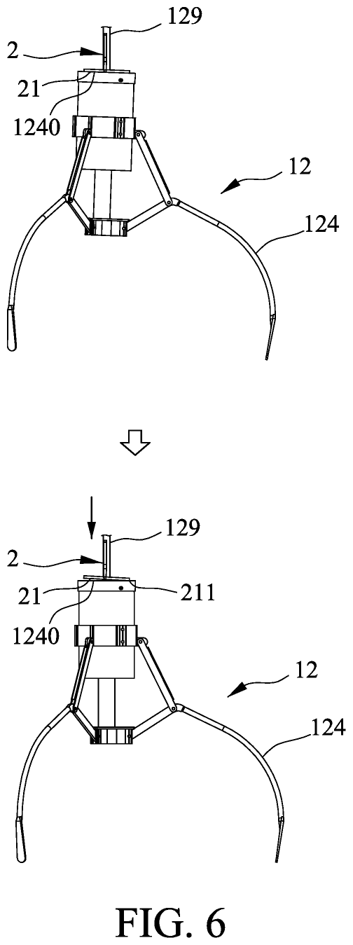

Afterward, the processor 5 generates and transmits a release signal to the rotating motor 123, so as to cause the rotating motor 123 to release the cable 129 by a predetermined descending distance, thereby putting the claw 124 down by the predetermined descending distance and to move the claw 124 back to a non-tilted position (for example, as seen in FIG. 6 which illustrates the claw 124 being dropped to break full contact with the limiting member 2 and being in contact with the inclination part 21 only at the lowest point 211). It is noted that the predetermined descending distance may be set to any value that enables the top surface 1240 of the claw 124 to not contact the inclination part 21. The above operations are implemented to ensure that before the start of each game, the claw 124 is in the non-tilted position.

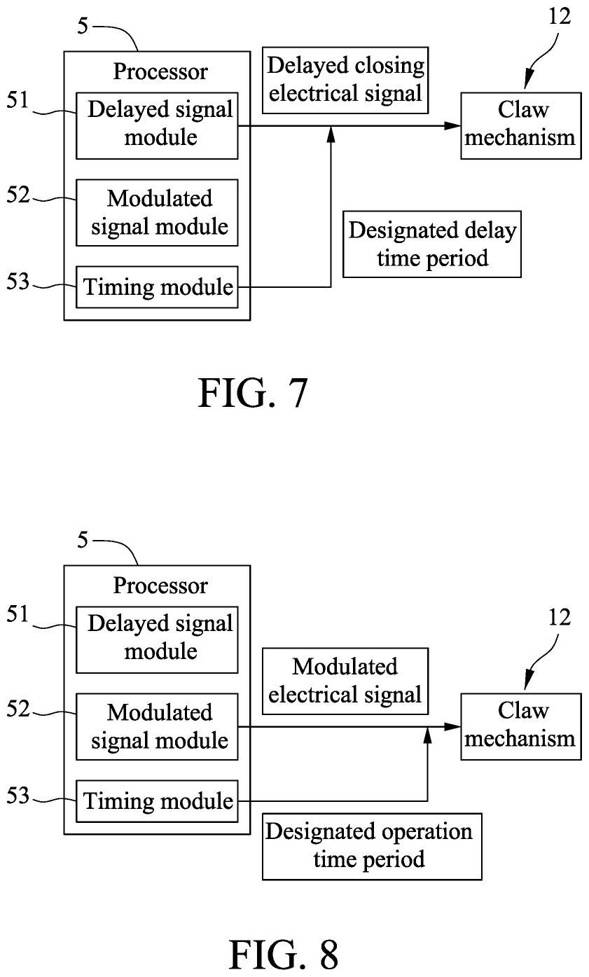

In some embodiments, the claw machine 1 may be configured to operate in a second operation mode according to one embodiment of the disclosure. FIG. 7 illustrates the signal transmission between the processor 5 and the claw mechanism 12 in the second operation mode.

In the second operation mode, after the player presses the button for generating the closing electrical signal (i.e., for controlling the claw 124 to close), the delayed signal module 51 is configured to generate a delayed closing electrical signal, and the timing module 53 may be configured to generate a designated delay time period to be associated with the delayed closing electrical signal. Specifically, the designated delay time period may be a random number between about 0.1 second to about 0.5 second. In some embodiments, the timing module 53 may be configured to generate the designated delay time period using a pre-stored parameter table.

The processor 5 then transmits the resulting delayed closing electrical signal to the driving module 125 to serve as the closing electrical signal, and in response to receipt of the resulting delayed closing electrical signal, the driving module 125 controls the claw 124 to close after the designated delay time period (as opposed to immediately controlling the claw 124 to close).

In some embodiments, the claw machine 1 may be configured to operate in a third operation mode according to one embodiment of the disclosure. FIG. 8 illustrates the signal transmission between the processor 5 and the claw mechanism 12 in the third operation mode.

In the third operation mode, after the player presses the button for generating the closing electrical signal (i.e., for controlling the claw 124 to close), the modulated signal module 52 generates a modulated electrical signal to serve as the closing electrical signal, and the timing module 53 may be configured to generate a designated operation time period to be associated with the modulated electrical signal.

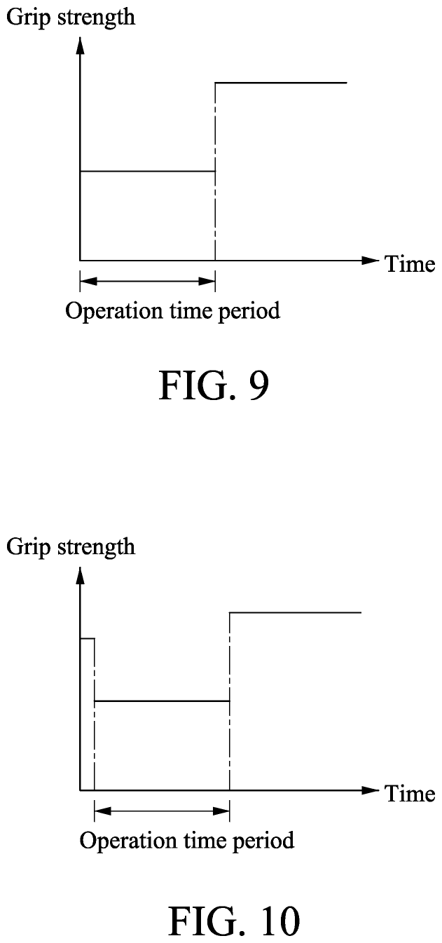

The processor 5 then transmits the resulting modulated electrical signal to the driving module 125, and in response to receipt of the resulting modulated electrical signal, the driving module 125 controls the claw 124 to first close using a first grip strength for the designated operation time period, and then (e.g., after the designated operation time period), to close using a second grip strength that is greater than the first grip strength. FIG. 9 illustrates the different grip strengths of the claw 124 over time in response to one exemplary modulated electrical signal. It is noted that the different grip strengths may be achieved using different electrical voltages based on the modulated electrical signal.

In one variation of the third operation mode, after the player presses the button for generating the closing electrical signal (i.e., for controlling the claw 124 to close), the modulated signal module 52 generates a modulated electrical signal, and the timing module 53 may be configured to generate a designated operation time period to be associated with the modulated electrical signal. It is noted that the generation of the designated operation time period may be done in a manner similar to the generation of the designated delay time period.

The processor 5 then transmits the resulting modulated electrical signal to the driving module 125, and in response to receipt of the resulting modulated electrical signal, the driving module 125 causes the claw 124 to first close using an initial grip strength, which is greater than the first grip strength, for an initial period (which is typically shorter than the designated operation time period). Afterward, the driving module 125 causes the claw 124 to close using the first grip strength for the designated operation time period. After the designated operation time period, the driving module 125 causes the claw 124 to close using the second grip strength. FIG. 10 illustrates the different grip strengths of the claw 124 over time in response to another exemplary modulated electrical signal. It is noted that using the modulated electrical signal as described in FIGS. 9 and 10, the players may be provided with additional variations of playing the game. It is noted that in general, the modulated electrical signal serves as the closing electrical signal and causes the claw 124 to close using different grip strengths during closing of the claw 124, and different arrangements of the different grip strengths and the designated operation time period may be employed.

To sum up, the embodiments of the disclosure provide a control system of a claw machine. The control system is configured to provide a number of operation modes to incorporate a number of possible different ways to play games with the claw machine.

According to embodiments of the disclosure, there is provided a claw machine assembly that includes the claw machine 1 and a control system 100 as shown in FIG. 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A control system for controlling a claw machine, the claw machine including a cabinet that defines an inner space and a claw mechanism that is disposed on a ceiling of the cabinet, the claw mechanism including a shell, a cable reel that is in disposed in the shell, a cable that has one end connected to the cable reel, a rotating motor that is connected to the cable reel to control the movement of the cable reel, a claw that is connected to another end of the cable, and a driving module that is configured to control the claw to close or open based on a control signal, the control system comprising:
a limiting member that has an installation part installed on the shell of the claw mechanism, and an inclination part extending from the installation part and inclined toward the claw;
a location sensor that is installed on the shell of the claw mechanism, and that is configured to generate a proximity signal when an object comes into proximity of the location sensor;
an operation interface that is connected to the rotating motor and the driving module, and that is operable to control operations of the claw mechanism; and
a processor connected to the location sensor, the operation interface, the rotating motor and the driving module;
wherein:
in response to user-operation on the operation interface, the processor generates and transmits a dropping signal to the rotating motor to cause the rotating motor to control the movement of the cable reel and release the cable, thereby dropping the claw;
in response to other user-operation on the operation interface, the processor generates and transmits a closing electrical signal to the driving module to cause the driving module to control the claw to close;
the processor generates and transmits a lifting signal to the rotating motor to cause the rotating motor to control the movement of the cable reel and retract the cable, thereby lifting the claw;
in the case where the claw has come into proximity of the location sensor, the location sensor generates a proximity signal and transmits the proximity signal to the processor;
in response to receipt of the proximity signal, the processor generates and transmits a fixed-distance movement signal to the rotating motor, so as to cause the rotating motor to retract the cable, thereby lifting the claw for a predetermined lifting distance;
after the fixed-distance movement signal is transmitted for a preset period, the processor generates and transmits an opening pulse signal to the driving module, so as to adjust the closing electrical signal from the driving module such that a grip strength of the claw is reduced.

2. The control system as claimed in claim 1, wherein the inclination part of the limiting member includes a lowest point, and, after the transmitting the opening pulse signal, the processor generates and transmits a release signal to the rotating motor, so as to cause the rotating motor to release the cable by a predetermined descending distance, thereby putting the claw down by the predetermined descending distance and enabling a top surface of the claw to not fully contact the inclination part.

3. The control system as claimed in claim 1, wherein the processor includes a delayed signal module that is configured to generate a delayed closing electrical signal that serves as the closing electrical signal which, when transmitted to the driving module, causes the driving module to control the claw to close after a designated delay time period.

4. The control system as claimed in claim 3, wherein the processor further includes a timing module that is configured to generate the designated delay time period.

5. The control system as claimed in claim 1, wherein the processor includes a modulated signal module that is configured to generate and transmit a modulated electrical signal to the driving module, and the modulated electrical signal serves as the closing electrical signal and causes the claw to close using different grip strengths during closing of the claw.

6. The control system as claimed in claim 5, wherein the processor generates the modulated electrical signal that causes the claw to first close using a first grip strength, and then close using a second grip strength that is greater than the first grip strength.

7. The control system as claimed in claim 6, wherein the processor generates the modulated electrical signal that causes the claw to first close using an initial grip strength, which is greater than the first grip strength, for an initial period before closing using the first grip strength.

8. The control system as claimed in claim 6, wherein the processor further includes a timing module that is configured to generate a designated operation time period to be associated with the modulated electrical signal, and the modulated electrical signal causes the claw to first close using the first grip strength for the designated operation time period, and, after the designated operation time period, close using the second grip strength.

9. A claw machine assembly comprising:
a claw machine that includes a cabinet that defines an inner space, and a claw mechanism that is disposed on a ceiling of the cabinet, the claw mechanism including
a shell,
a cable reel that is disposed in the shell,
a cable that has one end connected to the cable reel,
a rotating motor that is connected to the cable reel to control the movement of the cable reel,
a claw that is connected to another end of the cable, and
a driving module that is configured to control the claw to close or open based on a control signal; and
a control system for controlling the claw machine, including
a limiting member that has an installation part installed on the shell of the claw mechanism, and an inclination part extending from the installation part and inclined toward the claw;
a location sensor that is installed on the shell of the claw mechanism, and that is configured to generate a proximity signal when an object comes into proximity of the location sensor;
an operation interface that is connected to the rotating motor and the driving module, and that is operable to control operations of the claw mechanism; and
a processor connected to the location sensor, the operation interface, the rotating motor and the driving module;
wherein:
in response to user-operation on the operation interface, the processor generates and transmits a dropping signal to the rotating motor to cause the rotating motor to control the movement of the cable reel and release the cable, thereby dropping the claw;
in response to other user-operation on the operation interface, the processor generates and transmits a closing electrical signal to the driving module to cause the driving module to control the claw to close;
the processor generates and transmits a lifting signal to the rotating motor to cause the rotating motor to control the movement of the cable reel and retract the cable, thereby lifting the claw;
in the case where the claw has come into proximity of the location sensor, the location sensor generates a proximity signal and transmits the proximity signal to the processor;
in response to receipt of the proximity signal, the processor generates and transmits a fixed-distance movement signal to the rotating motor, so as to cause the rotating motor to retract the cable, thereby lifting the claw for a predetermined lifting distance;
after the fixed-distance movement signal is transmitted for a preset period, the processor generates and transmits an opening pulse signal to the driving module, so as to adjust the closing electrical signal from the driving module such that a grip strength of the claw is reduced.

10. The claw machine assembly as claimed in claim 9, wherein the inclination part of the limiting member includes a lowest point, and, after the transmitting the opening pulse signal, the processor generates and transmits a release signal to the rotating motor, so as to cause the rotating motor to release the cable by a predetermined descending distance, thereby putting the claw down by the predetermined descending distance and enabling a top surface of the claw to not fully contact the inclination part.

11. The claw machine assembly as claimed in claim 9, wherein the processor includes a delayed signal module that is configured to generate a delayed closing electrical signal that serves as the closing electrical signal which, when transmitted to the driving module, causes the driving module to control the claw to close after a designated delay time period.

12. The claw machine assembly as claimed in claim 11, wherein the processor further includes a timing module that is configured to generate the designated delay time period.

13. The claw machine assembly as claimed in claim 9, wherein the processor includes a modulated signal module that is configured to generate and transmit a modulated electrical signal to the driving module, and the modulated electrical signal serves as the closing electrical signal and causes the claw to close using different grip strengths during closing of the claw.

14. The claw machine assembly as claimed in claim 13, wherein the processor generates the modulated electrical signal that causes the claw to first close using a first grip strength, and then close using a second grip strength that is greater than the first grip strength.

15. The claw machine assembly as claimed in claim 14, wherein the processor generates the modulated electrical signal that causes the claw to first close using an initial grip strength, which is greater than the first grip strength, for an initial period before closing using the first grip strength.

16. The claw machine assembly as claimed in claim 14, wherein the processor further includes a timing module that is configured to generate a designated operation time period to be associated with the modulated electrical signal, and the modulated electrical signal causes the claw to first close using the first grip strength for the designated operation time period, and, after the designated operation time period, close using the second grip strength.
